(19) United States
(12) Patent Application Publication
(10) Pub. No.: US 2009/0150273 A1
(43) Pub. Date: Jun. 11, 2009

(54) Calculating an index that represents the price of a commodity

(75) Inventors: David Lehman, Oak Park, IL (US); Victor Frederick Seamon, Winthrop Harbor, IL (US)

Correspondence Address: McCracken & Frank LLP, 311 S. Wacker Drive, Suite 2500, Chicago, IL, 60606, US

(73) Assignee: Board of Trade of the City of Chicago, Inc.

(21) Appl. No.: 11/999,354

(22) Filed: Dec. 5, 2007

(51) Int. Cl. G06Q 40/00

(52) U.S. Cl. 705/35

(57) ABSTRACT

An index that represents a price of a commodity paid by a plurality of purchasers is calculated by identifying a first subset of purchasers from the plurality of purchasers. A second subset of purchasers is selected from the first subset of purchasers, prices are obtained from the purchasers that comprise the second subset, and a statistic of the prices is calculated to develop the index.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates generally to operation of a market and particularly to calculating a settlement price of a product traded at the market.

2. Background of the Invention

An exchange provides one or more venues for the purchase and sale of various types of products including financial instruments such as stocks, bonds, futures contracts, options, cash, swaps, and other similar instruments. A futures contract is a contract to purchase or sell an underlying commodity or financial instrument for delivery in the future at a price that is determined at the initiation of the contract.

Generally, the exchange establishes specifications for each product traded on a market. The specifications define at least the product traded in the market, minimum quantities that must be traded, and a minimum price increment in which the product can be traded. For some types of products, for example, futures contracts for commodities, the specification may further defines a quantity of the underlying commodity represented by one unit (or lot) of the product, an expiration date, and a delivery date for the underlying goods or financial instruments.

A bid is an order by a trader seeking to buy a quantity of the product and an offer is an order by a by a trader seeking to sell a quantity of the product. An order may include a bid or offer price and a quantity to be bought or sold, respectively. For example, a bid for a futures contract may be for a purchase of a quantity of 200 contracts at 95 dollars each.

Typically, only authorized traders are allowed to trade directly on the exchange. However, brokerages or persons who are not affiliated with the exchange may also place orders through authorized traders. Traders who trade on an exchange must have accounts at an authorized clearing firm. The authorized clearing firm guarantees any obligations incurred by the trader to a central clearing house associated with the exchange. Each trader's account at the authorized clearing firm is marked to market periodically (typically, daily) and subject to minimum performance bond (i.e., margin) requirements established by the exchange. The performance bond represents a good faith deposit by the trader to guarantee performance and represents a minimum amount of protection against potential losses incurred by the trader. Should the performance bond on deposit in a trader's account fall below a designated level, the account must be re-margined to the initial performance bond level. To determine if re-margining is required, all open positions held by the trader are marked to market during or at the end of each trading session by determining a settlement price and marking open positions to the settlement price. A net change in the value of a trader's account is computed based upon the settlement price and a value of all the open positions held in a trader's account is updated to reflect the net change. Without re-margining of the trader's account, the trader's ability to fulfill delivery obligations may be put in risk if the trader accumulates losses over time. Periodic settlement of accounts assures that all parties involved in trading through an exchange are solvent and can meet their obligations to one another and to the exchange.

In some cases, the settlement price that is used to mark to market the account of a trader who holds an open position in a product is related to the price at which the product was traded in the market. Determination of the settlement price in this manner is described in U.S. patent application Ser. No. 11/891,746, filed on Aug. 13, 2007, that is entitled “Method of Computing a Settlement Price,” has attorney reference number 80047/40200, and is incorporated herein by reference.

In other cases, the settlement price of a futures contract is based on the price or value of the product underlying the futures contract. For example, the daily settlement price of a futures contract based on an index is based on the value of the index at a predetermined time of each trading day. In volatile markets, the index may be calculated multiple times each day and margin requirements for traders and clearing firms may be adjusted in accordance with the calculated index.

An index may be considered a gauge of performance in a market. For example, the Dow Jones Industrial average is an index that can be used gauge performance of stocks of industrial companies that are traded in U.S. Exchanges. Similarly, an index for a commodity or traded product may be used to track the price of the commodity in one or more markets. For example, an index may provide a gauge for the price of corn (or another commodity) in the United States over time. One way to calculate the value of such an index is to poll each purchaser of corn (e.g., a grain elevator or warehouse) that purchases corn to determine the price being bid by the purchaser. The value of the index for corn may be calculated by averaging the prices being bid by all of the purchasers polled. A weighted average may also be used to calculate an index by multiplying a price paid by each purchaser with a weighting factor associated with the purchaser and calculating a sum the weighted prices. The value of the index is the result of the division of the sum of the weighted prices and a sum of the weighting factors. The weighting factors may reflect the relative size of the purchaser (i.e., number of transactions per annum, number of bushels of corn purchased by the purchaser, the time of day of the bid, or the location of the purchaser) or may indicate some other quality of the purchaser.

For agricultural products, the purchasers tend to be local entities near the farms where the agricultural product is harvested. Some purchasers purchase directly from a farmer and other purchasers may purchase commodities from, typically, smaller purchasers. The price paid by a purchaser may vary locally (or regionally) because of, for example, local growing conditions, local demand, costs of transporting the commodity between the purchaser and other purchasers, end-users or processors, etc.

Because of the local nature of purchasing and warehousing of agricultural products there are many purchasers of such products. For example, there are over 2,800 grain elevators in the United States that purchase corn; over 1,700 grain elevators that purchase wheat; and over 2,500 grain elevators that purchase soybeans. In addition there are over 2,100 feedlots that purchase cattle and over 500 energy wholesalers that purchase electricity. In addition, there are over 1,700 fuel wholesalers in the United States that sell motor fuel to the transportation industry. Calculating a value of an index for an agricultural product by polling each purchaser of the product requires a significant amount of time and, therefore, the daily value of the index may not be available in time for such value to be used to manage intra-day risk associated with a trader or as the settlement price for a futures contract based on the index.

FIG. 1 depicts boxes 100A-D that represent regions in which purchasers for a particular product may be located and the number in each box 100A-D represents the number of purchasers in the region represented by the box 100A-D. A total of 1,255 purchasers are represented by the boxes 100A-D. In order to calculate an index for a commodity purchased by each of the 1,255 purchasers, a spot price is obtained from each purchaser. The spot price may be obtained electronically from some of the purchasers, but others may have to be contacted to obtain the price being bid thereby. If the average time per purchaser to obtain a price is 3 minutes per purchaser, then to calculate the index based on information from all 1,255 purchasers requires 3,765 person-minutes or 62.75 person-hours. At least 8 people are needed to obtain the prices to calculate an index within an 8-hour period.

Even if some of the purchasers provide price information via network connections between the entity collecting the price information and the purchasers, a staff member may still have to call the purchaser to verify the information provided thereby. Also, smaller or less affluent purchasers may not have the capabilities necessary to automate the price reporting. Further, purchasers located in remote or very rural areas may not have access to the types of communications infrastructure necessary to automatically report price information. It should be apparent that for at least these reasons, and for other reasons that may be apparent to one having skill in the art, calculating an index for a product having a large number of purchasers requires significant resources (i.e., time and resources). It should also be apparent that the resources required for calculating the index increase as the number of purchasers from whom price information must be obtained increases. The resource requirements are compounded when the index needs to be calculated by a particular time each trading day or multiple times each trading day for settling of futures contracts based on the index or to manage risk associated with the traders who trade in such futures contracts.

### SUMMARY OF THE INVENTION

In one aspect of the present invention a method of calculating an index that represents a price of a commodity includes identifying a first subset of purchasers from a plurality of purchasers and randomly selecting a second subset of purchasers from the first subset. Prices from purchasers of the second subset are obtained and an index is developed by calculating a statistic of such prices.

In another aspect of the invention, a method of trading an instrument associated with a commodity in a market includes identifying a plurality of purchasers of the commodity and designate a subset of the plurality of purchasers from whom to obtain prices. A first index is calculated in accordance with a statistic of prices obtained from purchasers randomly selected from the subset, and a second index is calculated from prices obtained from the plurality of purchasers. The first index is evaluated to determine whether a trader may trade the instrument in the market.

In still another aspect of the invention, a method of measuring prices of a commodity offered by purchasers includes associating each of the purchases into a first category and into a second category in accordance with at least one predetermined criterion. A first and a second subset of purchasers are selected from the purchasers associated with the first and second category, respectively. Prices are obtained from a predetermined number of purchasers randomly selected from the first category and from a predetermined number of purchasers randomly selected from the second category. An index is calculated in accordance with a statistic of such prices and the index is transmitted.

Other aspects and advantages of the present invention will become apparent upon consideration of the following detailed description.

### BRIEF DESCRIPTION OF THE DRAWINGS

FIG. 1 illustrates four regions, each of which have purchasers of a commodity;

FIG. 2 illustrates the purchasers in the four regions of FIG. 1 organized into subsets;

FIG. 3 illustrates the number of purchasers in each subset illustrated in FIG. 2 from whom prices are to be obtained;

FIG. 4 illustrates three regions, each of which have purchasers of a commodity, wherein the purchasers are grouped by category;

FIG. 5 illustrates how purchasers in each of the categories illustrated in FIG. 4 are separated into subsets and the number of purchasers in each subset from whom prices are to be obtained;

FIG. 6 depicts an embodiment of calculating an index for a commodity;

FIG. 7 depicts another embodiment of calculating an index for a commodity;

FIG. 8 shows an embodiment of obtaining prices that may be used by the embodiments depicted by FIGS. 6 and 7.

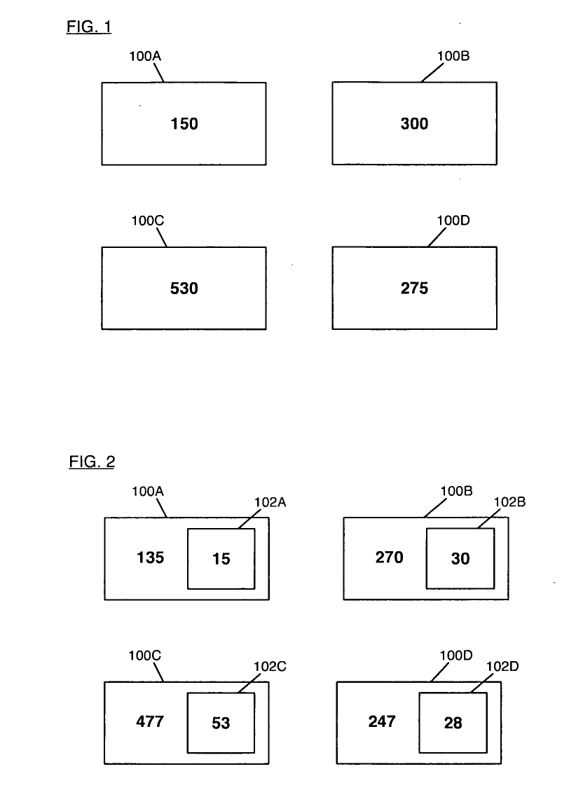

### DETAILED DESCRIPTION OF THE PREFERRED EMBODIMENTS

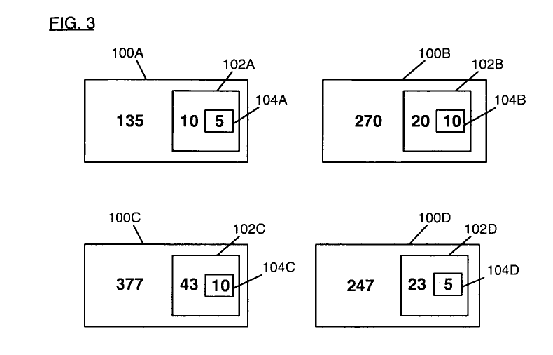

FIG. 2 depicts a way of separating the purchasers into regions represented by boxes 100A-D to facilitate calculating an index. In particular, a subset of purchasers is identified in each region represented by the boxes 100A-D, wherein the purchasers included in the subset are candidates for providing prices that may be used to calculate the index. The number of purchasers in each such subset is identified in the boxes 102A-D. For example, of 150 purchasers in the region represented by the box 100A, the subset of purchasers in such region comprises 15 purchasers. The 15 purchasers of the subset are selected so that the subset is representative of all 150 purchasers in the region. For example, the purchasers of a subset may be selected based on the storage capacity thereof. In particular, if 10% of all of the purchasers in a region are able to store at least a predetermined amount of an commodity, then 10% of the purchasers for the subset selected for that region should be able to store at least the predetermined amount of the commodity. Other criteria that may be used to select purchasers for the subset include historical volatility of prices, geographic distance to other purchasers or a predetermined location, type of equipment used by the purchasers, level of automation, etc. More than one such criterion may be used to determine the composition of the subset. Typically, the purchasers of the subset associated with the region are determined periodically and do not vary on a daily basis. In some cases, the purchasers of the subset may be selected annually or once every few years. In other cases, the subset may be analyzed periodically to ensure the purchasers of the subset associated with the region are indeed representative of all of the purchasers in that region. In this case, if the subset is not representative, some purchasers may be removed from the subset and others added thereto so that the subset becomes more representative of all of the purchasers in the region.

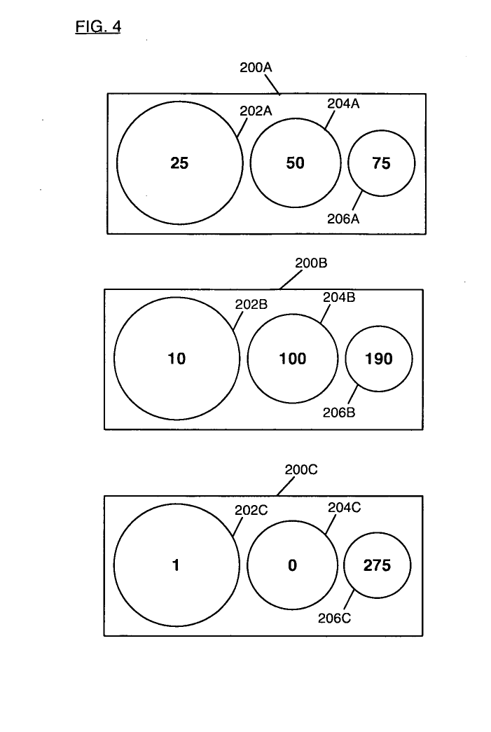

FIG. 3 depicts boxes 100A-D that represent regions. For each of the regions, the boxes 102A-D show the number of purchasers selected to be in the subset associated with the region corresponding to the box and as described above. To calculate the index for the commodity purchased by the purchasers shown in FIG. 3, the price from each of a randomly selected portion (shown by boxes 104A-D) of each subset of purchasers (shown by the boxes 102A-D) of each region (shown by the boxes 100A-D) is obtained. For example, the box 100A represents 150 (135+10+5) purchasers that are in the region represented by the box 10A. The box 102A shows that of the 150 such purchasers, 15 (10+5) have been selected to form a subset of the purchasers who are candidates for providing prices that may be used in calculating the index. The box 104A shows that of the 15 purchasers selected in the subset, prices obtained from 5 purchasers randomly selected from the subset are used to calculate the index.

A sum of prices obtained from each of the purchasers that are represented by the boxes 104A-D is calculated. The index is calculated by dividing the sum of prices by the number of prices obtained (which for the purchasers represented in FIG. 3 is 30). In some embodiments, a weighting factor associated with a purchaser reporting a price is multiplied by the price reported thereby, a sum of the weighted prices from all of the selected purchasers (i.e., those represented by the boxes 104A-D) is calculated. Thereafter, the index is calculated by dividing the sum of the weighted prices by a sum the weighting factors. The weighting factor may be varied in accordance with one or more criteria associated with the purchaser. Examples of criteria that may be used to determine the weighting factor include the volume of the commodity purchased or sold by the purchaser, variety of commodities purchased, number and/or size of producers in proximity to the purchaser, historical correlation of prices provided by the purchaser and the index, etc. The index may be published or otherwise provided to traders, exchanges and clearinghouses for use in settling trades and managing risk associated with positions held by traders.

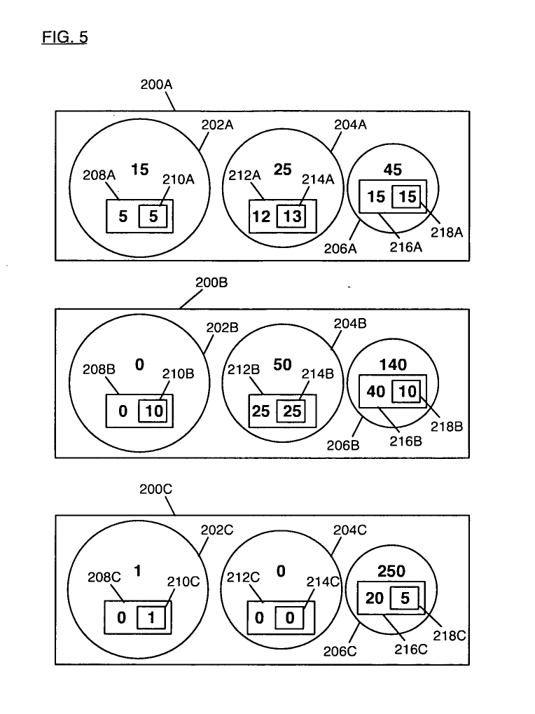

FIG. 4 depicts boxes 200A-C, which represent three regions. The purchasers in each region have been separated into three categories in accordance with one or more criteria. Each box 200A-C comprises three circles 202A-C, 204A-C, 206A-C and each circle represents a category of purchasers. Inside each circle is a number that indicates the number of purchasers represented by that circle. For example, if the criteria is storage capacity and the three categories are high, medium, and low capacities then the box 200A represents 150 purchasers (25+50+75) and each has been separated into one of the categories in accordance with the storage capacity thereof. In this example, suppose circles 202A, 204A, and 206A represent purchasers who have high, medium, and low storage capacities, respectively. Then FIG. 4 shows that in the region represented by the box 200A, 25 purchasers are categorized as having high storage capacity, 50 purchasers are categorized as have medium storage capacity, and 75 purchasers have low storage capacity. Similarly, the circles 202B, 204B, and 206B inside the box 200B represent the purchasers who have high, medium, and low storage capacity in the region represented by the box 200B; and the circles 202C, 204C, and 206C inside the box 200C represent the purchasers who have high, medium, and low storage capacity in the region represented by the box 200C. Note, that the region represented by the box 200C has one purchaser that has high storage capacity (represented by the circle 202C) and 275 purchasers who have low storage capacity (represented by the circle 206C). Further, none of the purchasers in the region represented by the box 200C have medium storage capacity.

The number of categories shown in FIG. 4 is representative and the purchasers in a region may be separated into any number of categories in accordance with one or more criteria. Furthermore, it should be apparent that although the above describes separating purchasers in accordance with the storage capacity thereof, any other criterion (such as those described above) or a combination of criterion may be used to selected the purchasers that comprise a category.

FIG. 5 illustrates purchasers in each category who are further separated into representative subsets and the number of random purchasers from each subset that are polled to calculate the index of the commodity. In particular, with respect to the region represented by the box 200A, of the 25 purchasers that make up the category represented by the circle 202A, 10 purchasers (5+5) are selected to form a subset that is representative of the category in such region and the box 208A represents this subset of purchasers. Typically, the purchasers of a subset associated with a category are representative of the purchasers for the category in accordance with certain criteria, such as those described hereinabove. Continuing with FIG. 5, of the 10 purchasers (represented by the box 208A) of the subset associated with the category represented by the circle 202A, 5 purchasers are randomly selected (represented by the box 210A) and such purchasers are contacted to obtain price information. In a similar fashion, prices are obtained from the purchasers represented by the boxes 210B-C, 214A-C, and 218A-C that are selected from the subsets represented by the boxes 208B-C, 212A-C, and 216A-C, respectively.

Note that with respect to the category represented by the circle 202B in the region represented by the box 200B, all of the 10 purchasers of the category are in the subset that is representative of the category. Further, as shown by the boxes 208B and 210B, prices are to be obtained from all of the purchasers in the subset each time an index is calculated. This situation may occur, for example, if there is significant diversity among the purchasers in the category and a representative subset of such purchasers cannot be formulated.

In contrast, as shown by the box 218C, prices are obtained from only 5 of the purchasers in the category represented by the circle 206C. Further, the 5 purchasers are selected from 25 purchasers that comprise the subset that is representative of all of the purchasers in the category represented by the box 216C. This situation may occur, for example, if there is little diversity among the purchasers in a particular category and a few purchasers in the category are sufficient to form a subset that is representative of the total.

It should be apparent that the number of regions and the number of purchasers therein, the number of categories and the number of purchasers therein, and the number of purchasers in subsets and the number of purchasers randomly selected therefrom described herein above are for exemplary purposes only and that such quantities may vary in various embodiments.

In order to calculate an index price for a commodity, each of the randomly selected purchasers represented by the boxes 210A-C, 214A-B, and 218A-C are contacted to obtain the price being paid thereby for the commodity (as is evident in FIG. 5, no purchasers are represented by the box 214C). The prices obtained from each of the randomly selected purchasers 210A-C, 214A-B, and 218A-C are summed and the sum is thereafter divided by the number of purchasers represented by the boxes 210A-C, 214A-B, and 218A-C (which in this example is 84 purchasers). In some embodiments, a weighted sum is calculated by applying a weighting factor to each price obtained from a purchaser and the weighted sum is divided by the sum of the weighting factors to calculate the index. In some instances, the weighting factor applied to a price obtained from a purchaser is in accordance with the category to which the purchaser belongs. For example, considering the purchasers illustrated in FIG. 5, a first weighting factor may be associated with the categories represented by the circles 202A-C and the first weighting factor is applied to the prices provided by each of the purchasers represented by the boxes 210A-C; a second weighting factor may be associated with the categories represented by the circles 204A-C and such weighting factor is applied to the prices provided purchasers represented by the boxes 214A-C; and a third weighting factor may be associated with the categories represented by the circles 206A-C that is applied to each of the prices obtained by the purchasers represented by the boxes 218A-C. The first, second, and third weighting factors may be identical or the weighting factors may be dependent on characteristics of the region in which purchasers associated with the factor belong.

In some embodiments, the randomly selected purchasers, for example those represented by the boxes 210A-C, 214A-C, and 218A-C, are contacted first to obtain prices offered thereby for the commodity to calculate a first index price for the commodity in the manner described above. After the first index price is calculated and published, the remaining purchasers of the commodity, for example the remaining purchasers in the regions represented by the boxes 200A-C, are contacted and the prices provided by such purchasers are used to calculate a second index price. The second index price may also be published. In some embodiments, the first index price is used as an intra-day price and the second index price may be used as an end-of-trading session index price. The intra-day price may be used to assess risk during a trading session or to consider margin requirements of traders. The end-of-trading session index price may be used to mark-to-market accounts of traders or for settling positions held by traders. It should be apparent that multiple intra-day prices may be calculated

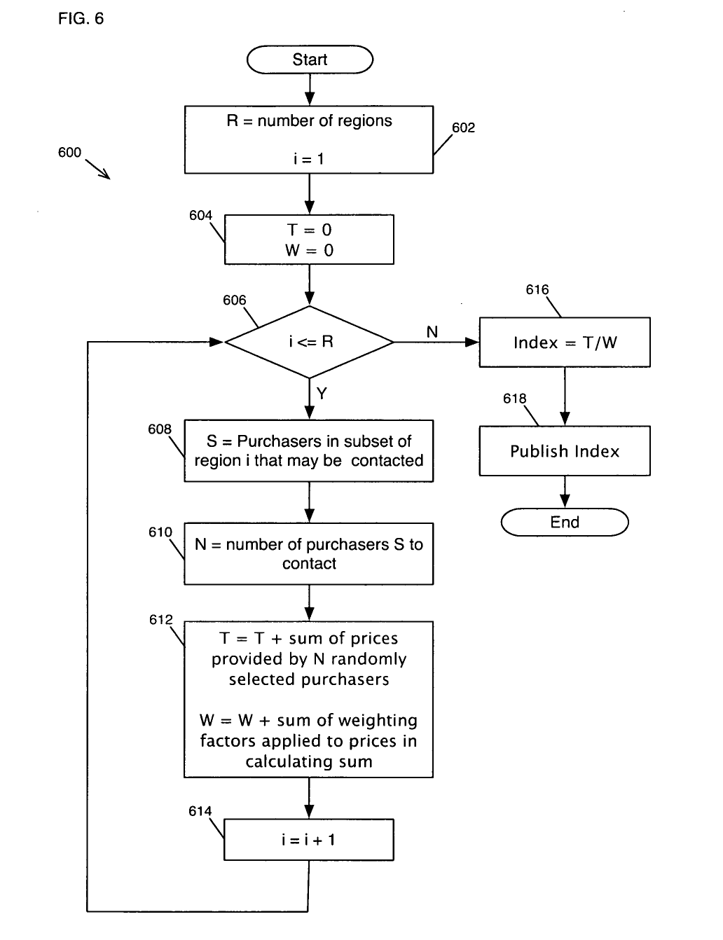

FIG. 6 shows a flowchart of an embodiment 600 that calculates an index for a commodity. A block 602 sets a value of a variable R to the number of regions where purchasers of the commodity are located. The block 602 also sets the value of a counter i to 1. A block 604 sets values of variables T and W to 0. A block 606 determines if the value of the counter i is less than or equal to the value of the variable R and, if so, branches to a block 608.

The block 608 sets the value of a variable S to the purchasers in the subset of the i^{th} region that may be contacted. In some embodiments, the variable S is an array of information about the purchasers. Other ways of storing and managing the information about a group of purchasers (such as those represented by the variable S) that could be used to store such information should be apparent to those who have skill in the art.

The block 610 sets a value of a variable N to the number of purchasers represented by the variable S that are to be contacted. For example, with respect to the scenario illustrated in FIG. 3, the value of the variable R is set to 4, and for a first region (e.g., the region represented by the box 10A), the value of the variable S is set to information about the 15 purchasers that are represented by the box 102A, and the value of the variable N is set to 5.

Continuing with FIG. 6, a block 612 obtains prices from purchasers randomly selected from the purchasers represented by the value of the variable S and calculates a sum of such prices. The number of purchasers that are randomly selected is identical to the value of the variable N. The block 612 also increments the value of the variable T by the sum of prices from the randomly selected purchasers.

In some cases, the block 612 calculates a weighted sum of the prices, wherein a weighting factor is applied to each price from a purchaser and the weighted price is included in the sum. In such cases, block 612 adds the weighted sum of the prices provided by the randomly selected purchasers to the value of the variable T. The block 612 also calculates a sum of the weighting factors used to calculate the weighted sum and add the sum of the weighting factors to the value of the variable W.

A block 614 increments the value of the counter i and proceeds to the block 606. The blocks 606 through 614 loop in this manner until the value of counter i is no longer less than or equal to the value of the variable R when tested by the block 606. When the value of the counter i exceeds the value of the variable R, the block 606 branches to a block 616, which sets a value of a variable Index to the value that results from dividing the value of the variable T (i.e., weighted sum of prices) by the value of the variable W (i.e., sum of weighting factors).

A block 618 publishes the value of the variable Index by transmitting such value to reporting systems. The block 618 may also make the value of the variable Index available to systems used by exchanges, clearing firms, clearing houses, etc. or to staff members at such entities.

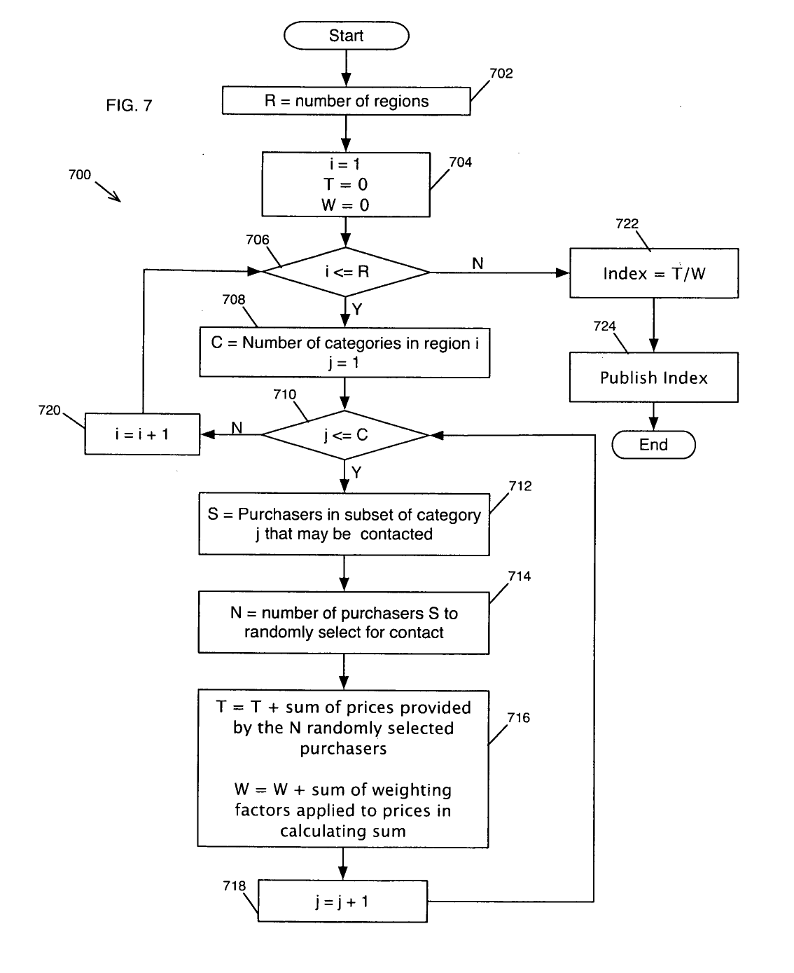

FIG. 7 shows a flowchart of another embodiment 700 that may be used to calculate an index price for a commodity. Specifically, a block 702 sets the value a variable R to the number of regions where purchasers from whom prices are to be obtained are located. A block 704 sets values of a counter i to 1 and the values of the variables T and W to zero. A block 706 compares the value the counter i to the value of the variable R. If the value of the counter i is less than or equal to the value of the variable R, the block 706 branches to a block 708. The block 708 sets a value of a variable C to the number of categories in the i^{th} region and a value of a counter j to 1.

A block 710 determines whether the value of the counter j is less than or equal to the value of the variable C, and if so, branches to the block 712. The block 712 sets the value of a variable S to information about purchasers that include the subset in the j^{th} category of the i^{th} region that may be contacted. A block 714 sets the value of a variable N to the number of purchasers that are represented by the value of the variable S that are to be randomly selected and from whom prices are to be obtained. A block 716 increments the value of the variable T by a sum of prices obtained from the randomly selected purchasers, wherein the sum may be a weighted or an unweighted sum of the prices as described above. The block 716 also increments the value of the variable W by the sum of the weighting factors applied to the prices in calculating a weighted sum of the prices (if a non-weighted sum is calculated, then the value of the variable W is incremented by a value that is identical to the value of the variable N).

The block 718 adds one to the value of the counter j and proceeds to the block 710. As described above, the block 710 compares the value of the counter j to the value of the variable C and if the value of the counter j is less than or equal to the value of the variable C branches to the block 712. Otherwise, the block 710 branches to the block 720, which adds 1 to the value of the counter i. Thereafter, the block 706 compares the values of the counter i and the variable R and branches to the block 708 if the value of the counter i is less than or equal to the value of the variable R; otherwise, the block 706 branches to a block 722. The block 722 sets a value of a variable Index to the result of dividing the value of the variable T by the value of the variable W.

A block 724 thereafter publishes or provides the value of the variable Index as described above.

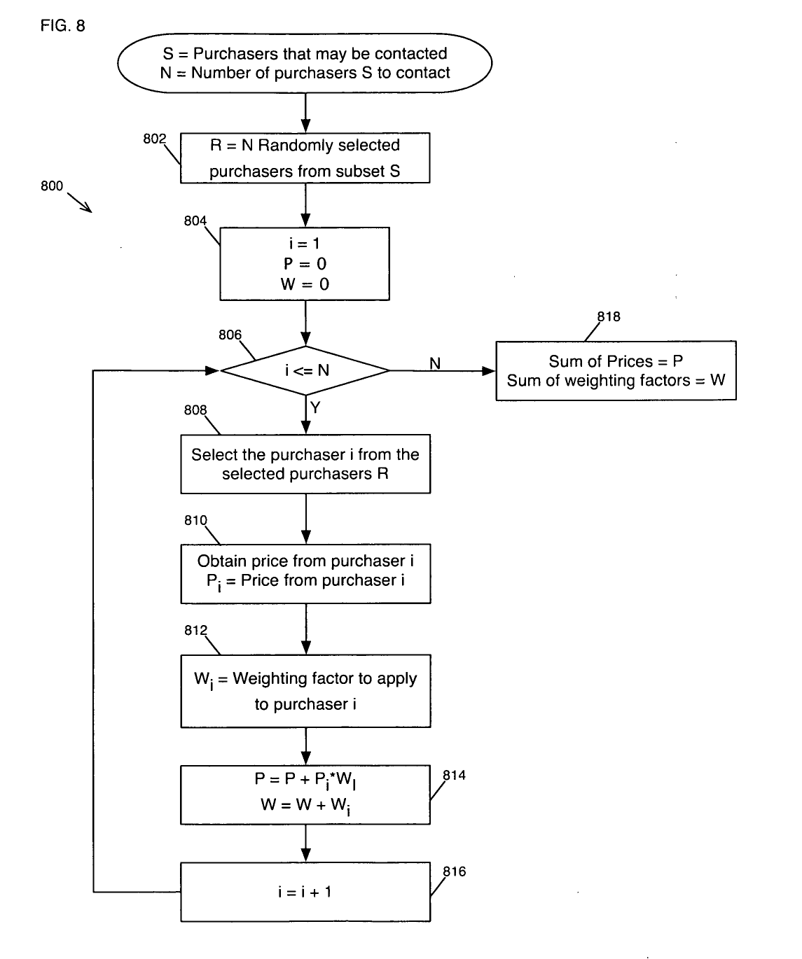

FIG. 8 show a flow chart of an embodiment 800 that obtains prices from purchasers and calculates a weighted sum of such prices. The blocks 612 and 716 shown in FIGS. 6 and 7, respectively, may use the embodiment 800. As described above, the value of the variable S has information about purchasers who may be contacted and the value of the variable N is the number of the purchasers (from those represented by the value of the variable S) that are randomly selected and from whom prices are obtained. A block 802 randomly selects the requisite number (N) of purchasers from those represented by the value of the variable S. A block 804 initializes a value of a counter i to 1 and values of variables P and W to 0.

A block 806 compares the values of the variables i and N and if the value of the variable i is less than or equal to the value of the variable N, the block 806 branches to a block 808. The block 808 selects the i^{th} purchaser from the purchasers represented by the value of the variable R. A block 810 obtains a price being paid for the commodity from the i^{th} purchaser selected by the block 808 and sets the value of a variable Pᵢ to such price. In some embodiments, information about the purchaser selected at the block 808 is provided to a staff member, who calls the selected purchaser to obtain the price. In such embodiments, the price obtained by the staff member is provided at an input (not shown) to the block 810, which sets the value of the variable Pᵢ to the value of the price provided by the staff member. In other embodiments, the price is obtained electronically from a system operated by the purchaser selected at the block 808.

A block 812 determines a value of a weighting factor Wᵢ that is to be applied to the price obtained at the block 810. In some embodiments, that value of the weighting factor Wᵢ is part of the information about purchasers stored in the values of the variables R and/or S, and in such embodiments the block 810 extracts the value therefrom. In other embodiments, the value of the weighting factor Wᵢ is determined by querying a database using information about the purchaser that is stored in the values of the variables R and/or S.

A block 814 calculates the product the price provided by the i^{th} purchaser (Pᵢ) and the weighting factor Wᵢ and adds the product to the value of the variable P. The block 814 also adds the value of the weighting factor Wᵢ to the value of the variable W.

A block 816 increments the value of the counter i and proceeds to the block 806. The block 806 once again compares the values of the counter i. The blocks 808 through 816 are executed as long as the value of the counter i is less than or equal to the value of the variable N. Upon determining that the value of the counter i exceeds the value of the variable N, the block 806 branches to a block 818. The block 818 sets the sum of prices to the value of the variable P and the sum of weighting factors to the value of the variable W. The use of these sums was shown above in connection with the descriptions of the blocks 612 and 716 of FIGS. 6 and 7, respectively.

Some embodiments 800 do not use the variable W if an identical weighting factor is applied to the prices obtained from purchasers. In such embodiments, the block 814 does not need to add the weighting factor Wᵢ to the value of the variable W. Instead, the sum of weighting factors is identical to the value of the variable N (i.e., the number of purchasers contacted) multiplied by the weighting factor.

Some embodiments 800 do not obtain prices serially from purchasers. Instead the block 802 generates a call list that provides information about purchasers who are to be contacted including a name of the purchaser, contact person at the purchaser's facility, one or more telephone numbers, etc. One or more staff members use the call list to obtain prices from purchasers on the call list. The staff member thereafter enters the price information into the system at blocks 808 and 810 of embodiment 800. In some cases, the block 808 prompts the staff member to enter information and the block 810 reads information provided by the staff member. In other cases, all of the price information is entered into a database or file and the block 810 reads the price information from such database or file (the block 808 may, in such cases, generate an appropriate query for the database).

Although the embodiments herein describe calculating the index by calculating an average or a weighted average of the prices obtained from purchasers, it should be apparent that the index may be calculating another statistic of the prices. For example, other types of averages may be used such as a geometric mean, a quadratic mean, harmonic mean, etc. In addition, the index may be based on statistics such as a median or a mode of the prices.

The exemplary embodiments described herein in FIGS. 6-8 may be implemented using any number of computing systems including those running Solaris developed by Sun Microsystems, Windows developed by Microsoft, or the Macintosh Operating System Developed by Apple Computer. Furthermore, the programming necessary may be undertaken using any of a number of programming languages including C, C++, Objective C, Java, Smalltalk, etc. It should be apparent to those having skill in the art how to integrate the embodiments described herein into call center applications and other communications systems for obtaining prices from purchasers. In addition, it should be apparent to such persons how to disseminate the index developed by the embodiments described herein.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

I/We claim:

1. A method for calculating a index that represents a price of a commodity paid by a plurality of purchasers, the method comprising:
identifying a first subset of purchasers from the plurality of purchasers;
randomly selecting a second subset of purchasers from the first subset of purchasers;
obtaining prices from purchasers of the second subset of purchasers; and
developing the index by calculating a statistic of the prices obtained from purchasers and publishing the index.

2. The method of claim 1, where developing the index comprises the step of calculating a mean.

3. The method of claim 2, where calculating a mean comprises the step of calculating an arithmetic mean.

4. The method of claim 1, where obtaining prices from purchasers comprises the step of receiving a price via electronic communication.

5. The method of claim 1, wherein the commodity comprises an agricultural product.

6. The method of claim 1, wherein the commodity comprises an energy source.

7. A method of trading a financial instrument associated with a commodity in a market exchange, the method comprising:
identifying a plurality of purchasers of the commodity;
designating a subset of the plurality of purchasers from whom to obtain prices;
calculating a first index in accordance with a statistic of prices obtained from purchasers randomly selected from the subset;
calculating a second index in accordance with a statistic of the prices obtained from the plurality of purchasers; and
evaluating the first index to determine whether a trader may trade the instrument.

8. The method of claim 7, further comprising adjusting an account of a trader in accordance with the first index.

9. The method of claim 8, further comprising marking-to-market the account of the trader.

10. The method of claim 8, further comprising settling an account of a trader in accordance with the second index.

11. The method of claim 7, further comprising calculating a third index in accordance with a statistic of prices obtained from the purchasers randomly selected from the subset and wherein the steps of calculating the first index and the third index are undertaken during a common trading session.

12. The method of claim 7, further comprising authorizing a trader to trade in the market in accordance with the first index.

13. A method of measuring prices of a commodity offered by a plurality of purchasers, the method comprising:
associating each of the plurality of purchasers into a first category and into a second category in accordance with at least one predetermined criterion;
selecting a first subset of purchasers from the plurality of purchasers associated with the first category;
selecting a second subset of purchasers from the plurality of purchases associated with the second category;
obtaining prices from a predetermined number of purchasers randomly selected from the first subset and a predetermined number of purchasers randomly selected from the second subset;
calculating an index in accordance with a statistic of the prices; and
transmitting the index.

14. The method of claim 13, where the criterion comprises volume of the commodity purchased by the purchaser.

15. The method of claim 13, where the criterion comprises the commodities purchased by the purchaser.

16. The method of claim 13, where calculating the index comprises the step of calculating a mean.

17. The method of claim 13, where calculating a mean comprises the step of calculating an arithmetic mean.

18. The method of claim 13, where obtaining prices from purchasers comprises receiving a price via an electronic communication.

19. The method of claim 13, where the commodity comprises an agricultural product.

20. The method of claim 13, further comprising adjusting an account of a trader in accordance with the index.

21. The method of claim 20, further comprising marking to market the account of the trader.

22. The method of claim 20, further comprising:
obtaining further prices from the predetermined number of purchasers randomly selected from the first subset and the predetermined number of purchasers randomly selected from the second subset; and
calculating a further index in accordance with a statistic of the prices; and
wherein the steps of calculating the index and the further index are undertaken during a common trading session.

23. The method of claim 20, further comprising authorizing a trader to trade a financial instrument associated with the commodity.
